(19) United States
(12) Patent Application Publication
(10) Pub. No.: US 2010/0057375 A1
(43) Pub. Date: Mar. 4, 2010

(54) Structure of NOx sensor and its calculating method of total total NOx concentration

(76) Inventors: JinSu Park, Daejeon (KR); Chong-Ook Park, Daejeon (KR)

Correspondence Address: CLARK & BRODY, 1090 VERMONT AVENUE, NW, SUITE 250, WASHINGTON, DC, 20005, US

(21) Appl. No.: 12/230,533

(22) Filed: Aug. 29, 2008

(51) Int. Cl. G01N 27/406

(52) U.S. Cl. 702/23; 204/425

(57) ABSTRACT

The present invention relates to a NOₓ sensor and a calculating method of total NOₓ concentration using the same, and more particularly, to a NOₓ sensor which has improved sensitivity to NO and NO₂ and simply calculates NO, NO₂ and total NOₓ concentration, and a calculating method of total NOₓ concentration using the same.

The NOₓ sensor of the present invention comprises an oxygen ion conductive solid electrolyte 10; an oxide sensing electrode 20 formed at the oxygen ion conductive solid electrolyte 10; a noble metal electrode 30; and a lead line 40 connected to each of the oxygen ion conductive solid electrolyte 10 or the oxide sensing electrode 20 or the noble metal electrode 30, wherein the oxygen ion conductive solid electrolyte 10 and the oxide sensing electrode 20 form at least two interfaces.

Further, the calculating method of total NOₓ concentration of the present invention comprises the steps of a) measuring voltages or currents of each of two or more NOₓ sensors 100 as described above; b) substituting the measured voltages or currents into a series of NOₓ concentration calculating formulars of each of the NOₓ sensors 100 so as to calculate NO and NO₂ concentrations separately; and c) adding the NO and NO₂ concentrations so as to calculate the total NOₓ concentration.

According to the NOₓ sensor and the calculating method of measuring total NOₓ concentration using the same, it is possible to prevent the deterioration of the sensitivity even in an atmosphere that the NO accounts for a major percent, thereby increasing the measurement precision. And by using a simple method in which the electromotive force measured in two or more sensors or two or more interfaces is substituted into the NOₓ concentration calculating formular, it is possible to facilely calculate the NO, NO₂ and NOₓ concentration.

### TECHNICAL FIELD

The present invention relates to a NOₓ sensor and a calculating method of total NOₓ concentration using the same, and more particularly, to a NOₓ sensor which has improved sensitivity to NO and NO₂ and simply calculates NO, NO₂ and total NOₓ concentration, and a calculating method of total NOₓ concentration using the same.

### BACKGROUND ART

When nitrogen contained in combustion air and fuel is combined with oxygen by influence of temperature and the like, nitrogen oxide is generated, and the nitrogen oxide including NO, NO₂ and N₂O₃ is expressed as NOₓ.

Particularly, the NO₂ is a maroon colored poisonous gas having a pungent smell. The NO and NO₂ accounting for a major percent of the whole NOₓ are mainly generated from a transportation means and becomes a cause of air pollution. Therefore, there is an increased necessity of measuring NOₓ concentration.

As a conventional NOₓ sensor for measuring the NOₓ concentration, there has been proposed a mixed potential type NOₓ sensor as shown in FIG. 1a.

Referring to FIG. 1, the mixed potential type NOₓ sensor includes an oxygen ion conductor 110 using stabilized zirconia; an oxide sensing electrode 120 formed at one side of the oxygen ion conductor 110; a noble metal electrode 130; and a noble metal reference electrode 140. And the mixed potential type NOₓ sensor is characterized by measuring an electromovite force generated between both ends of the noble metal electrode 130 and the noble metal reference electrode 140.

In the mixed potential type NOₓ sensor, since the oxide sensing electrode 120 has reactivity to NOₓ and oxygen, but the reference electrode 140 has reactivity only to oxygen, an electromovite force generated between the reference electrode 140 and the oxide sensing electrode 120 is occurred according to the NOₓ concentration contained in gas. And the difference of electromotive force is measured and thus a NOₓ amount is measured.

FIG. 1b is a graph showing the electromotive force of the NOₓ sensor at 700° C. and an oxygen partial pressure of 5% in case that it is exposed to a gas where NO or NO₂ accounts for a major percent.

As shown in FIG. 1b, the NO₂ accounts for a major percent before 80 minutes, and the NO accounts for a major percent after 80 minutes. In case that the NO₂ is the major component of the gas, the measured electromotive force has a similar shape with NO₂ concentration. However, in case that the NO is a major composition, it can be understood that the NOₓ sensor can not normally carry out its function due to remarkable reduction of its sensibility caused by the NO.

That is, in the mixed potential type NOₓ sensor, if the NO₂ is existed in the gas, reactions take place according to the following formulas (1) and (2), and if the NO is existed, reactions take place according to the following formulas (3) and (4):

$$\begin{matrix}\begin{matrix}In case of {NO}_{2} \text{:} & {NO}_{2} + 2 {e}^{-} \to NO + {O}^{2 -} \\ & {O}^{2 -} \to 1 / 2 {O}_{2} + 2 {e}^{-}\end{matrix} & \begin{matrix}( 1 ) \\ ( 2 )\end{matrix} \\ \begin{matrix}In case of NO \text{:} & NO + {O}^{2 -} \to {NO}_{2} + 2 {e}^{-} \\ & 1 / 2 {O}_{2} + 2 {e}^{-} \to {O}^{2 -}\end{matrix} & \begin{matrix}( 3 ) \\ ( 4 )\end{matrix}\end{matrix}$$

As represented by the formulas (1) to (4), a sign of the electromotive force generated between the noble metal electrode like Pt or gold and the oxide sensing electrode in case of that the NO is present is contrary to that of the electromotive force generated between the noble metal electrode and the oxide sensing electrode in case of that the NO₂ is present. Therefore, in case that the NO and NO₂ are mixed together like in the automobile gas atmosphere, the NOₓ sensor using a mixed potential type has a disadvantage that it is difficult to measure the total NOₓ concentration due to the characteristic that the electromotive forces tend to move in opposite direction for NO and NO₂ exposure.

FIG. 1c is a graph showing the electromotive force in case that NiO as the sensing electrode is formed in the NOₓ sensor, and FIG. 1d is a graph showing the electromotive force in case that CuO as the sensing electrode is formed in the NOₓ sensor. With reference to FIGS. 1c and 1d, it can be understood that accuracy of the NOₓ sensor is deteriorated due to reduction of the electromotive force caused by increase of NO, although the NO₂ concentration is constantly maintained or increased. It means that the NOₓ sensor simply using the mixed potential can not be used in the mixed gas of the NO and NO₂.

In actuality, in case that the NiO is used as the sensing electrode, as shown in FIG. 1c, if the NO concentration is changed from 10 ppm to 100 ppm, a change in the electromotive force is −6.5 mV, and if the NO₂ concentration is changed from 10 ppm to 100 ppm, a change in the electromotive force is 83.7 mV. As shown in FIG. 1d, in case that the CuO is used as the sensing electrode, if the NO concentration is changed from 10 ppm to 100 ppm, a change in the electromotive force is −3.4 mV, and if the NO₂ concentration is changed from 10 ppm to 100 ppm, a change in the electromotive force is 66.0 mV.

As described above in terms of their sensitivities, there is a problem that, although the NO has a high concentration, the conventional mixed potential type NOₓ sensor can not sense it in the presence of NO₂.

To solve the above problem, there has been proposed a calculating method of total NOₓ concentration, in which a conversion cell 150 having a multi-layer structure is provided at an inlet port through which measurement gas is introduced so that the NOₓ is converted to a single component and thus unified into the NO or the NO₂ so as to measure the total NOₓ concentration, as shown in FIG. 2.

In the above-mentioned method, the unifying process for converting NO₂ to NO or converting NO to NO₂ should be performed. However, since the conversion cell 150 has a limit to convert the mixture gases to the NO or NO₂ completely, it is difficult to precisely measure the total NOₓ concentration in the mixture gas.

### DISCLOSURE OF THE INVENTION

It is an object of the present invention to provide a NOₓ sensor which can separately measure the NO and the NO₂ concentration, and also which can improve reactivity of the NO in an atmosphere that the NO accounts for a major percent so as to precisely measure the NO concentration.

It is another object of the present invention to provide a calculating method of total NOₓ concentration using the same, which can facilely calculate the total NOₓ concentration by adding the separately measured NO and NO₂ concentrations which are obtaind from NOₓ concentration calculating formulars.

To achieve the objects, the present invention provides NOₓ sensor, comprising an oxygen ion conductive solid electrolyte; an oxide sensing electrode formed at the oxygen ion conductive solid electrolyte; a noble metal electrode; and a lead line connected to each of the oxygen ion conductive solid electrolyte or the oxide sensing electrode or the noble metal electrode, wherein the oxygen ion conductive solid electrolyte and the oxide sensing electrode form at least two interfaces.

Preferably, in the NOₓ sensor, NOₓ concentration is calculated by voltages measured after a constant currents is applied between the two interfaces of the oxide sensing electrodes 20 or by currents measured after a constant voltages is applied between the two interfaces of the oxide sensing electrodes 20.

Preferably, at least two or more oxide sensing electrodes 20 are formed on a surface of the oxygen ion conductive solid electrolyte 10, or the oxide sensing electrode 20 is formed on upper and lower surfaces of the oxygen ion conductive solid electrolyte 10.

Preferably, two or more oxygen ion conductive solid electrolytes 10 are formed to be apart from each other at a predetermined distance, and the oxide sensing electrode 20 is interposed between the oxygen ion conductive solid electrolytes 10, or two or more oxide sensing electrodes 20 are formed to be apart from each other at a predetermined distance, and the oxygen ion conductive solid electrolyte 10 is interposed between the oxide sensing electrodes 20.

Preferably, the oxygen ion conductive solid electrolyte 10 is formed from one of the selected from; stabilized zirconia, CeO₂ or ThO₂, and the oxide sensing electrode 20 is formed from one or more oxides selected from NiO, CuO, NiO—YSZ, LaCoO₃, ZnO or 2CuO.Cr₂O₃, and the noble metal electrode 30 is formed of platinum or gold.

Further, the present invention provides a calculating method of total NOₓ concentration, comprising the steps of a) measuring voltages of each of two or more NOₓ sensors 100 as described above; b) substituting the measured voltages into a series of NOₓ concentration calculating formular of each of the NOₓ sensors 100 so as to calculate NO and NO₂ concentrations separately; and c) adding the NO and NO₂ concentrations so as to calculate the total NOₓ concentration.

For example, the NOₓ concentration calculating formular has a form of V=a₁lnP_{NO2}−a₂P_{NO}+a₃, and coefficients of the NOₓ concentration calculating formular is changed according to the forming materials and the process of the oxide sensing electrode 20 and currents applied to the NOₓ sensor 100.

Furthermore, the present invention provides a calculating method of total NOₓ concentration, comprising the steps of a) measuring currents from two or more pairs of interfaces of a NOₓ sensor 100 as described above; b) substituting the measured currents into a series of NOₓ concentration calculating formulars of each of the NOₓ sensors 100 so as to calculate NO and NO₂ concentrations separately; and c) adding the NO and NO₂ concentrations so as to calculate the total NOₓ concentration.

### BRIEF DESCRIPTION OF THE DRAWINGS

FIG. 1a is a schematic view of a conventional mixed potential type NOₓ sensor.

FIG. 1b is a graph showing electromotive force of the NOₓ sensor of FIG. 1a in case that NO or NO₂ accounts for a major percent.

FIG. 1c a graph showing the electromotive force in case that NiO as a sensing electrode is formed for the NOₓ sensor of FIG. 1a.

FIG. 1d is a graph showing the electromotive force in case that CuO as the sensing electrode is formed for the NOₓ sensor of FIG. 1a.

FIG. 2 is a schematic view of another conventional NOₓ sensor.

FIG. 3a is a schematic view of a NOₓ sensor according to the present invention.

FIG. 3b is a graph showing the voltage in case that NiO and CuO as sensing electrodes are respectively formed for the NOₓ sensor of FIG. 3a.

FIG. 3c is a graph showing the voltage in case that NiO and LaCoO₃ as sensing electrodes are respectively formed for the NOₓ sensor of FIG. 3a.

FIG. 4 is a schematic view of another NOₓ sensor according to the present invention.

FIG. 5 is a schematic view of yet another NOₓ sensor according to the present invention.

FIG. 6a is a schematic view of yet another NOₓ sensor according to the present invention.

FIG. 6b is a graph showing the voltage in case that NiO—YSZ, NiO, CuO, 2CuO.Cr₂O₃ as sensing electrodes are respectively formed for the NOₓ sensor of FIG. 6a.

FIG. 7a is a schematic view of yet another NOₓ sensor according to the present invention.

FIG. 7b is a graph showing the voltage in case that NiO—YSZ as a sensing electrode is formed for the NOₓ sensor of FIG. 7a.

FIG. 8 is a flow chart showing a calculating method of total NOₓ concentration.

### DETAILED DESCRIPTION OF MAIN ELEMENTS

100: NOₓ sensor

10: oxygen ion conductive solid electrolyte

20, 20-1, 20-2, 20-3, 20-4: oxide sensing electrode

30: noble metal electrode

40: lead line

Sa˜Sc: steps for calculating total NOₓ concentration

### BEST MODE FOR CARRYING OUT THE INVENTION

Practical and presently preferred embodiments of the present invention are illustrative as shown in the following Examples and Comparative Examples.

A NOₓ sensor of the present invention includes an oxygen ion conductive solid electrolyte 10; an oxide sensing electrode 20 formed at the oxygen ion conductive solid electrolyte 10; a noble metal electrode 30; and a lead line 40 connected to each of the oxygen ion conductive solid electrolyte 10 or the oxide sensing electrode 20 or the noble metal electrode 30. The oxygen ion conductive solid electrolyte 10 and the oxide sensing electrode 20 form at least two interfaces.

The oxygen ion conductive solid electrolyte 10 is formed from one of the selected from stabilized zirconia, CeO₂ or ThO₂, and the oxide sensing electrode 20 is formed from one or more mixtures selected from NiO, CuO, ZnO or NiO—YSZ, or one or more oxides selected from LaCoO₃ or 2CuO.Cr₂O₃, and if two or more oxygen ion conductive solid electrolytes 10 and oxide sensing electrodes 20 are formed, they may be respectively formed of the same material or other materials.

In the NOₓ sensor 100 of the present invention, the oxygen ion conductive solid electrolyte 10 and the oxide sensing electrode 20 may be formed into various shapes so as to have two or more interfaces. It will be explained below with the help of the schematic drawings for an examples, but the NOₓ sensor 100 of the present invention are not limited to their specific structures.

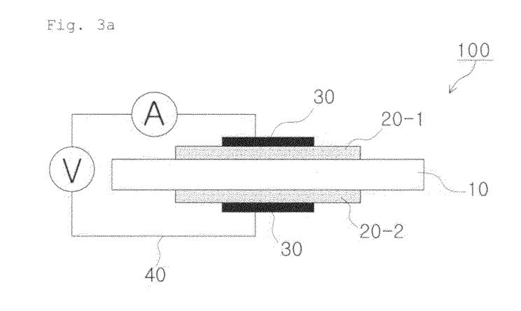

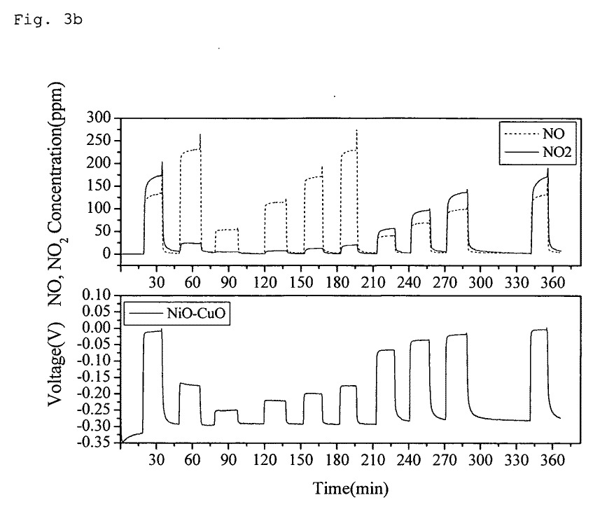

FIG. 3a is a schematic view of the NOₓ sensor 100 according to the present invention, wherein the oxide sensing electrode 20 is formed at each of upper and lower surfaces of the oxygen ion conductive solid electrolytes 10, and the two oxide sensing electrodes 20 are respectively formed with different materials.

According to the NOₓ sensor 100 as described above, if an electrical bias is applied to the oxide sensing electrode 20, reactivity to NO₂ is enhanced at the negative electrode, while reactivity to NO is enhanced at the positive electrode.

FIG. 3b is a graph showing the voltage of the NOₓ sensor 100 of FIG. 3a in case that the negative electrode is formed of NiO and the positive electrode is formed of CuO and currents of 5 μA is applied at a temperature of 700□ and an oxygen partial pressure of 10%, and FIG. 3c is a graph showing the voltage obtained from the NOₓ sensor 100 of FIG. 3a in case that the negative electrode is formed of NiO and the positive electrode is formed of LaCoO₃ and currents of 5 μA is applied at a temperature of 700□ and an oxygen partial pressure of 10%.

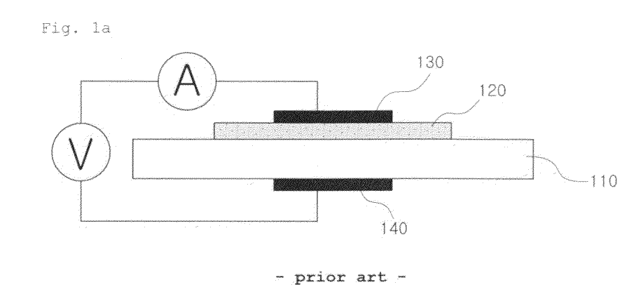

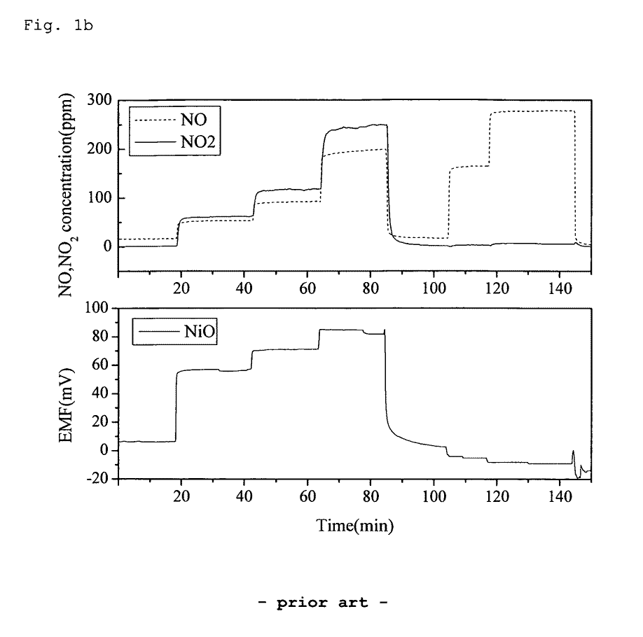

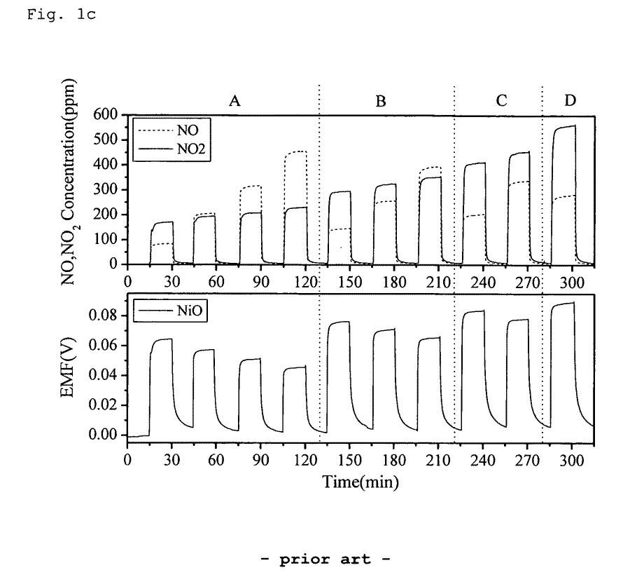

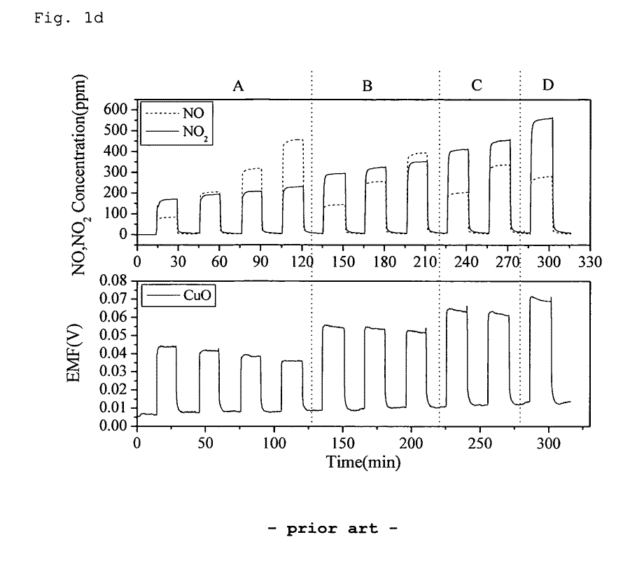

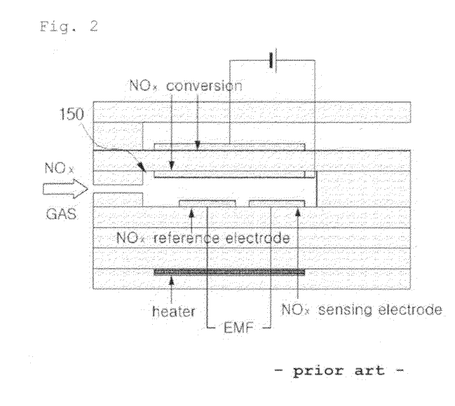

As shown in FIGS. 3b and 3c, it can be understood that sensitivity to NO is remarkably increased in comparison with the conventional NOₓ sensor of FIGS. 1c and 1d, which has only a single interface of oxide electrode. That is, on the basis of the graph of FIGS. 1c and 1d, the electromotive force according to NO and NO₂ concentration can be expressed by following experimental formulas (1) and (2):

EMF=0.03635lnP_{NO2}−72.31P_{NO}+0.3829 (1)

EMF=0.02866lnP_{NO2}−37.40P_{NO}+0.2941 (2)

Further, on the basis of the graph of FIGS. 3b and 3c, the voltage according to NO and NO₂ concentration can be expressed by following experimental formulas (3) and (4):

V=0.07228lnP_{NO2}−192.9P_{NO}+0.6471 (3)

V=0.06427lnP_{NO2}−91.29P_{NO}+0.4355 (4)

Comparing with the formulas (1) and (2) and the formulas (3) and (4), it can be understood that a coefficient with respect to NO concentration (P_{NO}) in of FIGS. 3b and 3c is considerably increased compared with a coefficient with respect to NO concentration (P_{NO}) in of FIGS. 1c and 1d.

Substantially, in the NOₓ sensor 100 according to the present invention, as shown in FIG. 3a, the sensitivity to NO₂ is increased twice or more and the sensitivity to NO is increased three times or more as compared with the convention NOₓ sensor of FIG. 1a. Therefore, the NOₓ sensor 100 of the present invention can precisely measure an amount of NOₓ in case that the NO or NO₂ accounts for a major percent.

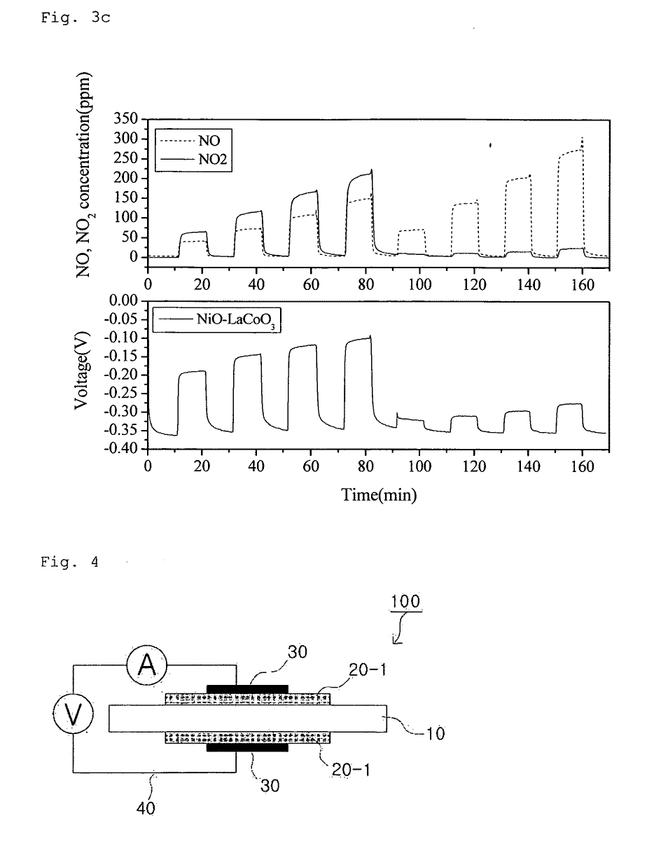

FIG. 4 is a schematic view of another NOₓ sensor 100 according to the present invention. The NOₓ sensor 100 of FIG. 4 has the same structure as that of FIG. 3a, but the oxide sensing electrodes 20-1 formed at the upper and lower surfaces of the oxygen ion conductive solid electrolyte 10 are made of the same material.

In the NOₓ sensor 100 of FIG. 4 in which the same oxide sensing electrode 20 is formed at the upper and lower surfaces thereof, if an electrical bias is applied, reactivity to NO₂ is enhanced at the negative electrode, and reactivity to NO is enhanced at the positive electrode.

FIG. 5 is a schematic view of yet another NOₓ sensor 100 according to the present invention, wherein two oxygen ion conductive solid electrolytes 10 are provided and an oxide sensing electrode 20 is interposed between the oxygen ion conductive solid electrolytes 10 so as to form two interfaces.

In the NOₓ sensor 100 of FIG. 5, if an electrical bias is applied to the interfaces formed between the upper and lower oxygen ion conductive solid electrolytes 10 and the oxide sensing electrode 20, reactivity to NO₂ is enhanced at the negative electrode, and reactivity to NO is enhanced at the positive electrode.

Besides the NOₓ sensor 100 of FIG. 5, the present invention may be constructed so that two or more oxygen ion conductive solid electrolytes 10 are formed to be apart from each other at a predetermined distance and the oxide sensing electrode 20 is interposed between the two oxygen ion conductive solid electrolytes 10.

Further, the NOₓ sensor 100 of the present invention may be constructed so that two or more oxide sensing electrodes 20 are formed to be apart from each other at a predetermined distance and the oxygen ion conductive solid electrolyte 10 is interposed between the two oxide sensing electrodes 20.

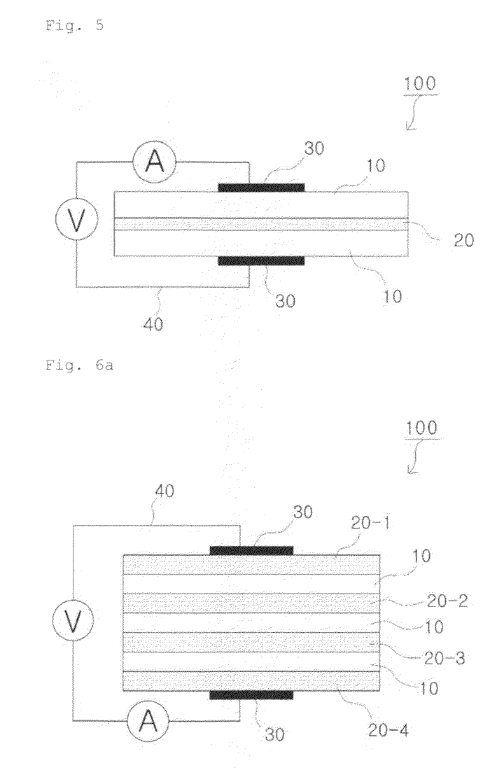

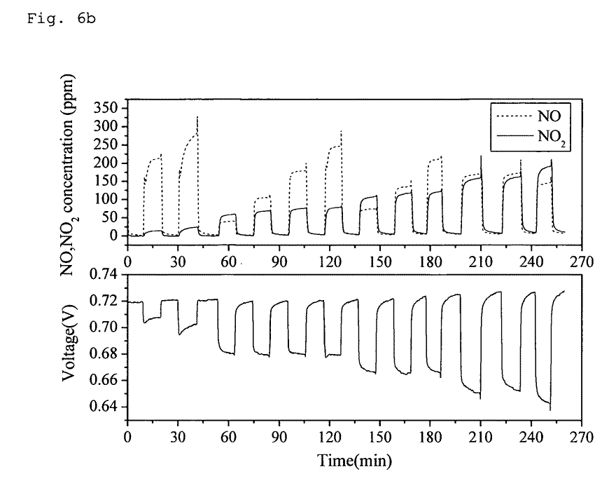

FIG. 6a is a schematic view of yet another NOₓ sensor 100 according to the present invention, wherein four oxide sensing electrodes 20-1, 20-2, 20-3 and 20-4 which are respectively formed of different materials are provided to be apart from each other at regular intervals and the oxygen ion conductive solid electrolyte 10 is interposed between the oxide sensing electrodes(20-1, 20-2, 20-3, 20-4).

FIG. 6b is a graph showing the voltage in case that NiO—YSZ, NiO, CuO, 2CuO.Cr₂O₃ as sensing electrodes are respectively formed in the NOₓ sensor 100 of FIG. 6a, wherein the oxide sensing electrodes 20-1, 20-2, 20-3 and 20-4 of FIG. 6a are formed, in turn, of NiO—YSZ, NiO, CuO, 2CuO.Cr₂O₃ and currents of 1 μA is applied at a temperature of 700° C. and an oxygen partial pressure of 10%.

As shown in FIG. 6b, the NOₓ sensor 100 of the present invention has improved sensitivity to NO even in an atmosphere that the NO accounts for a major percent and thus has improved performance.

Furthermore, the NOₓ sensor 100 of the present invention is characterized in that two or more oxide sensing electrodes 20 are formed on one surface of the oxygen ion conductive solid electrolyte 10.

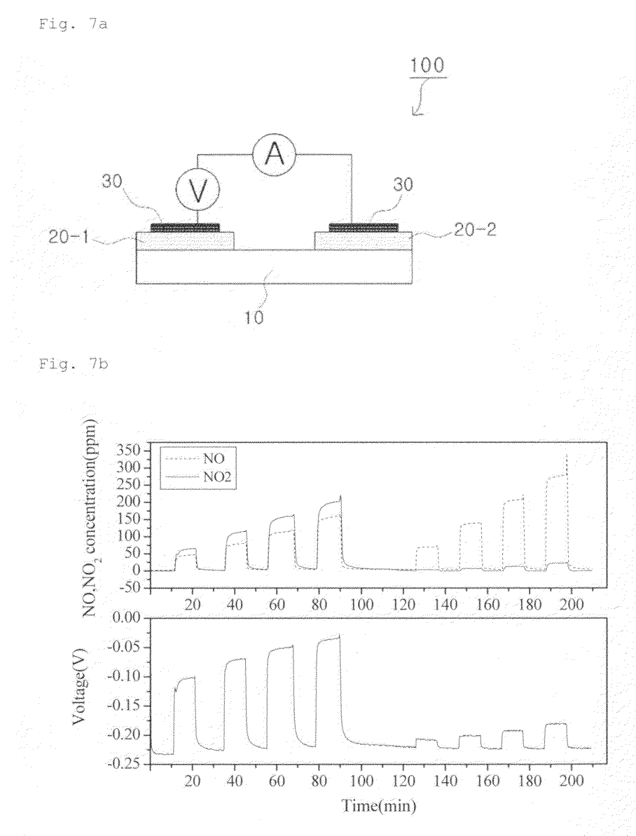

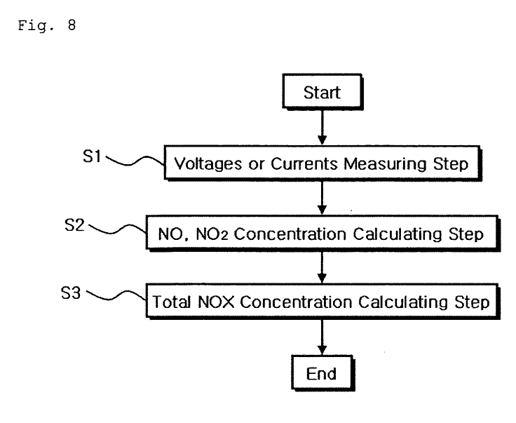

FIG. 7a is a schematic view of yet another NOₓ sensor 100 according to the present invention, wherein two oxide sensing electrodes 20 are formed on one surface of the oxygen ion conductive solid electrolyte 10.

FIG. 7b is a graph showing voltage in case that NiO—YSZ as a sensing electrode is formed in the NOₓ sensor 100 of FIG. 7a, wherein two sensing electrodes are formed of NiO—YSZ and currents of 10 μA is applied at a temperature of 700° C. and an oxygen partial pressure of 10%.

In other words, the NOₓ sensor 100 of the present invention may be constructed in various ways so that two or more interfaces between the oxygen ion conductive solid electrolyte 10 and the oxide sensing electrode 20 are formed so as to increase the sensitivity to NO, thereby precisely measuring total NOₓ concentration.

Meanwhile, a calculating method of total NOₓ concentration using the NOₓ sensor 100 of the present invention can be classified into a method using two sensors, and a method using a senser formed two or more pairs of oxide sensing electrode-electrolyte interfaces.

FIG. 8 is a flow chart showing a calculating method of total NOₓ concentration. The calculating method of total NOₓ concentration using the NOₓ sensor of the present invention includes the steps of: a) measuring voltages or currents (Sa); b) calculating NO and NO₂ concentration (Sb); and c) calculating total NOₓ concentration.

In the voltages or currents measuring step (Sa), voltages or currents may respectively measured using the two NOₓ sensors 100 of the present invention, or measured from two or more pairs of interfaces within one NOₓ sensor.

That is, the calculating method of total NOₓ concentration using the NOₓ sensor of the present invention can be classified into two types according to voltages or currents measuring method.

In the NO and NO₂ concentration calculating step (Sb), voltages or currents measured in the voltages or currents measuring step (Sa) is substituted into a NOₓ concentration calculating formular, and thus NO and NO₂ concentration can be calculated.

The NOₓ concentration calculating formular may be varied according to the materials which form the oxide sensing electrode 20, and the NOₓ concentration calculating formular can be expressed as follows:

V=a₁lnP_{NO2}−a₂P_{NO}+a₃

The coefficients of the NOₓ concentration calculating formular is changed according to the forming material and process of the oxide sensing electrode 20 and the current applied to the NOₓ sensor 100. In case that the oxide sensing electrode 20 of the NOₓ sensor 100 is formed of NiO and CuO and currents of 5 μA is applied to the NOₓ sensor 100, the values of a₁, a₂ and a₃ in the NOₓ concentration calculating formular are respectively 0.07228, −192.9 and 0.6471. And in case that the oxide sensing electrode 20 of the NOₓ sensor 100 is formed of NiO and LaCoO₃, the values of a₁, a₂ and a₃ in the NOₓ concentration calculating formular are respectively 0.06427, −91.29 and 0.4355. In case that the oxide sensing electrode 20 of the NOₓ sensor 100 is formed of NiO and CuO, the NOₓ concentration calculating formular of the NOₓ sensor 100 is the same as the formular (3), and in case that the oxide sensing electrode 20 of the NOₓ sensor 100 is formed of NiO and LaCoO₃, the NOₓ concentration calculating formular of the NOₓ sensor 100 is the same as the formular (4).

V=0.07228lnP_{NO2}−192.9P_{NO}+0.6471 (3)

V=0.06427lnP_{NO2}−91.29P_{NO}+0.4355 (4)

That is, the NO and NO₂ concentration calculating step (Sb) is to calculate each of the NO and NO₂ concentrations by substituting the measured voltage into the NOₓ concentration calculating formular.

In the total NOₓ concentration calculating step (Sc), the NO and NO₂ concentrations which are calculated in the NO and NO₂ concentration calculating step (Sb) are added so as to calculate the total NOₓ concentration.

According to the present invention as described above, since the sensitivity to NO can be increased, it is possible to precisely measure the NOₓ concentration. Also it is possible to facilely calculate NO, NO₂ and NOₓ concentration using a simple method.

### INDUSTRIAL APPLICABILITY

According to the NOₓ sensor and the calculating method of measuring total NOₓ concentration using the same, it is possible to prevent the deterioration of the sensitivity even in an atmosphere that the NO accounts for a major percent, thereby increasing the measurement precision. And by using a simple method in which the voltages or currents measured from two or more sensors or a sensor having two or more oxide electrode-electrolyte interfaces is substituted into the NOₓ concentration calculating formular, it is possible to facilely calculate the NO, NO₂ and NOₓ concentration.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A NOₓ sensor, comprising:
an oxygen ion conductive solid electrolyte 10;
an oxide sensing electrode 20 formed at the oxygen ion conductive solid electrolyte 10;
a noble metal electrode 30; and
a lead line 40 connected to each of the oxygen ion conductive solid electrolyte 10 or the oxide sensing electrode 20 or the noble metal electrode 30,
wherein there have at least more than two interfaces of between oxygen ion conductive solid electrolyte 10 and the oxide sensing electrode 20 to form a closed electric circuit to pass currents or apply voltage through the connecting lead line 40.

2. The NOₓ sensor as set forth in claim 1, wherein NOₓ concentration is obtained by voltages measured after a constant currents is applied between the two lead lines through which more than two interfaces of the oxide sensing electrodes 20 are involved in the electric circuit or by currents measured after a constant voltages is applied between the two lead lines through which more than two interfaces of the oxide sensing electrodes 20 are involved in the electric circuit.

3. The NOₓ sensor as set forth in claim 1, wherein at least two or more oxide sensing electrodes 20 are formed on a surface of the oxygen ion conductive solid electrolyte 10.

4. The NOₓ sensor as set forth in claim 1, wherein more than or equal to one oxide sensing electrode 20 are formed on upper and lower surfaces of the oxygen ion conductive solid electrolyte 10.

5. The NOₓ sensor as set forth in claim 1, wherein two or more oxygen ion conductive solid electrolytes 10 are formed to be apart from each other at a predetermined distance, and the oxide sensing electrode 20 is interposed between the oxygen ion conductive solid electrolytes 10.

6. The NOₓ sensor as set forth in claim 1, wherein two or more oxide sensing electrodes 20 are formed to be apart from each other at a predetermined distance, and the oxygen ion conductive solid electrolyte 10 is interposed between the oxide sensing electrodes 20.

7. The NOₓ sensor as set forth in claim 1, wherein the oxygen ion conductive solid electrolyte 10 is formed from one of the selected from; stabilized zirconia, CeO₂ or ThO₂.

8. The NOₓ sensor as set forth in claim 7, wherein the oxide sensing electrode 20 is formed from one or more oxides selected from NiO, CuO, NiO—YSZ, LaCoO₃, ZnOor 2CuO.Cr₂O₃.

9. The NOₓ sensor as set forth in claim 8, wherein the noble metal electrode 30 is formed of platinum or gold.

10. A calculating method of total NOₓ concentration, comprising the steps of:
a) measuring voltages or currents of each of two or more NOₓ sensors 100 according to claim 1;
b) substituting the measured voltages or currents into a series of NOₓ concentration calculating formulars of each of the NOₓ sensors 100 so as to calculate NO and NO₂ concentrations separately; and
c) adding the NO and NO₂ concentrations so as to calculate the total NOₓ concentration.

11. The calculating method of total NOₓ concentration as set forth in claim 10, wherein the NOₓ concentration calculating formular has a form of V=a₁lnP_{NO2}−a₂P_{NO}+a₃, where a₁, a₂, and a₃ are constants in case that we measure voltage.

12. The calculating method of total NOₓ concentration as set forth in claim 11, wherein coefficients of the NOₓ concentration calculating formular is changed according to the forming materials and the process of the oxide sensing electrode 20 or currents applied to the NOₓ sensor 100.

13. A calculating method of total NOₓ concentration, comprising the steps of:
a) measuring each voltages or currents from two or more pairs of interfaces of a NOₓ sensor 100 according to claim 1;
b) substituting the measured voltages or currents into a series of NOₓ concentration calculating formulars of each of the NOₓ sensors 100 so as to calculate NO and NO₂ concentrations separately; and
c) adding the NO and NO₂ concentrations so as to calculate the total NOₓ concentration.
